(19) United States
(12) Patent Application Publication
(10) Pub. No.: US 2001/0036354 A1
(43) Pub. Date: Nov. 1, 2001

(54) Multimedia memorial

(76) Inventor: Lisa M. Majors, Arlington, TX (US)

Correspondence Address: Richard C. Litman, LITMAN LAW OFFICES, LTD., P.O. Box 15035, Arlington, VA, 22215, US

(21) Appl. No.: 09/841,106

(22) Filed: Apr. 25, 2001

Related U.S. Application Data
(60) Provisional application No. 60/200,004, filed on Apr. 27, 2000.

(51) Int. Cl. H04N 5/92; H04N 5/76; G11B 31/00

(52) U.S. Cl. 386/46; 386/98; 369/69

(57) ABSTRACT

A multimedia memorial disposed at a grave site including a housing, power supply, an input, a memory, a microprocessor, a display for displaying a number of still images or successive moving images, a speaker, and an output. The multimedia memorial may also include a receiver and/or transmitter, such as a transceiver for receiving and/or transmitting information. Such a receiver may be configured for being responsive to global positioning system signals transmitted by a satellite navigation system and for providing information describing the memorial's location based on the navigation signals.

### CROSS-REFERENCE TO RELATED APPLICATION

This application claims the benefit of U.S. Provisional Patent Application Ser. No. 60/200,004, filed Apr. 27, 2000.

### BACKGROUND OF THE INVENTION

1. Field of the Invention

The present invention relates to a multimedia memorial for the playback of visual and/or audio recordings of a deceased at a gravesite.

2. Description of Related Art

People visit the gravesites of friends and loved ones to honor the memory of the departed, as well as part of the bereavement process. Many people would find the experience enhanced by viewing photographs or video of the deceased during the happier moments of his or her lifetime or hearing the sound of the deceased's voice.

There are, however, various problems with accommodating this desire at a gravesite, including exposure to the elements, security of the memorabilia and playback devices, etc. A number of devices have been devised which provide a personalized multimedia remembrance of an individual, including a few devices which can be located at a gravesite.

U.S. Pat. No. 4,169,970, issued on Oct. 2, 1979 to Michael L. Opiela et al., describes an audio reproduction system for use in conjunction with a tombstone for the repeated playback, upon activation, of a prerecorded message. The system includes a two part cylindrical housing inserted in a throughbore in a gravestone which houses a magnetic playback tape machine powered by batteries recharged by solar cells and activated by a Hall effect switch.

U.S. Pat. No. 5,404,343, issued on Apr. 4, 1995 to Bruce M. Boggio, describes a grave or resting place marker and audio system combination in which the sound is stored in nonvolatile RAM. The system can be housed in a wedge shaped housing placed between the slab and the gravestone, or part of the device may be buried in the ground and part stored in a recess in the marker or stone.

U.S. Pat. No. 5,504,836, issued on Apr. 2, 1996 to Alan R. Loudermilk, describes a picture frame and accompanying audio message circuit such that one or more desired audio messages associated with one or more displayed pictures can be played upon the touching of the pictures or the frame.

U.S. Pat. No. 5,553,426, issued on Sep. 10, 1996 to Denton L. Ostergaard, describes a gravesite container protected from theft by an attached anchor embedded in the earth or in concrete. The container may house an audio or video cassette.

U.S. Pat. No. 5,615,937, issued on Apr. 1, 1997 to Philippe Bellanger, describes a device for projecting or reflecting an image from a grave marker which uses a light source projected through a transparent image. U.S. Pat. No. 5,678,289, issued on Oct. 21, 1997 to Patrick M. Saaf, describes a device built into a casket for playing a musical theme from a CD which matches a design theme of the casket.

U.S. Pat. No. 5,729,921, issued on Mar. 24, 1998 to Joseph L. Rojas, describes a burial marker/display box for the preservation of memorabilia and/or ashes of an individual or individuals. The box contains a weatherproof cylinder which preserves the ashes and memorabilia. The box may also contain audio and video playback devices for viewing clips about the deceased.

U.S. Pat. No. 5,732,231, issued on Mar. 24, 1998 to Harry Evans, III, describes a display terminal mounted on a stand in a funeral home for displaying information about a deceased person whose visitation is or was in the funeral establishment. The display monitor may display audio and video from a CD-ROM, from audio-video cassettes, from the Internet, etc., and has switches for selecting what materials to view.

U.S. Pat. No. 5,812,545, issued on Sep. 22, 1998 to Burt Liebowitz, describes a satellite communication system which uses TDMA/DAMA (time division multiple access/demand assigned multiple access) switching technology to efficiently transmit voice, video, and bursty data.

Great Britain Patent No. 2,210,080, published on Jun. 1, 1989, describes a tombstone made of plastic that has at least one recess for receiving a plate for bearing details of the deceased.

International Patent document WO 81/02215, published on Aug. 6, 1981, describes a greeting card with a microminiature tone generator chip having a musical sequence stored in ROM.

An article entitled “A TALKING TOMBSTONE”, published Mar. 28, 1974 in the Wall Street Journal, describes a tombstone equipped with a recording of the deceased's voice, a projector to show scenes from his/her life, and a 20-foot scroll for biographical material.

None of the above inventions and patents, taken either singly or in combination, is seen to describe the instant invention as claimed.

### SUMMARY OF THE INVENTION

The present invention is a multimedia memorial. The multimedia memorial comprises a housing, power supply means, an input means, a memory means, a microprocessor means, a display means for displaying a number of still images or successive moving images, a speaker means, and an output means. The size of the housing is suitably designed insofar as it may be conveniently fixed in a convenient location according to the desires of the user, preferably near or associated with a sentimental item, such as a gravestone marker for an individual or an animal, such as a pet. The housing may be configured in the form of a non-breakable exterior pod or shell. The multimedia memorial may also include a receiver and/or transmitter, such as a transceiver for receiving and/or transmitting information. Such a receiver may be configured for being responsive to navigation signals transmitted by a satellite navigation system and for providing information describing the memorial's location based on the navigation signals, i.e. a global positioning system (GPS) receiver.

The power supply means of the multimedia memorial may be solar cell means. However, the power supply means may include any suitable power source, such as conventional storage batteries, rechargeable storage batteries, an electric outlet, or the like. The multimedia memorial includes appropriate drive circuitry associated therewith. The device may include a modem, cellular phone, wireless networking, or the like to be used in connecting with a PDA device, pocket PC, computer, the Internet or the like, for transferring and/or receiving data.

The input means of the multimedia memorial can receive image data from an image recording medium on which image data is recorded, such as a magnetic disc, a memory card, or the like. The input means may alternatively be configured in the form of a data port to enable data transfer and communication between the multimedia memorial and external peripheral devices. Such a data port may include a video port, an S-video port, an audio port, a serial port, a parallel port, a universal serial bus port, a firewire port, an infrared port, a radio frequency port, or the like. A universal serial bus port is a new type of port and data communication protocol that will permit a plurality of newly designed peripheral devices to be connected to the multimedia memorial in a daisy chain configuration. A firewire port is an audio/video digital interface according to the Institute of Electrical and Electronics Engineers 1394 standard. The other types of ports are well known to one skilled in the art. The input means may be configured on the back, the side, or the front of the multimedia memorial housing.

Such an image recording medium can be inserted into an opening in the input means. The image recording medium has a storage capacity with which image data representing a plurality of images can be recorded and with which sound can be recorded. The image data and the sound data can also be recorded on the image recording medium in a mixed state. Image data is read from the image recording medium and converted into digital signals by using a file reader means or a disc reader. The digital signals are stored in the memory means and displayed on the display means. The microprocessor means also contains an address memory by means of which the relevant images in the memory means can be called up. The address memory may be an EPROM or some other erasable programmable-read-only-memory. The address memory may also be replaceable, so that, if necessary, a programmed memory, corresponding to a relevant image, can be used. If the address memory is located in the microprocessor means, changes are relatively easy to make. The content of the memory means is processed successively by the microprocessor means. With the addresses and functional signals corresponding to the image data, the desired images are called up from the memory means and displayed on the display means. The memory means stores software code which includes program instructions defining the controlling logic. The microprocessor means implements the programmed control instructions. The controlling logic instructions may be coded in a variety of programming languages consistent and compatible with the particular hardware means employed.

Major known electrical components are mounted within the multimedia memorial and an external bus interface for upgrades and communication options. The components include a printed circuit board mounted in firm support within the multimedia memorial. The circuit board carries certain coupling and driver electronics with the microprocessor, read-only memories (ROM) and random access memories (RAM). In general, the ROM memories are used to contain instructions and programs while the RAM memories are employed for operating and working data. Of course, movement and process of instructions as well as data is controlled and accomplished by the microprocessor. The microprocessor is variously connected to the other elements of the multimedia memorial. The memories are connected to the microprocessor through several signal paths.

The output means of the multimedia memorial can output image data from the memory means on which image data is stored. The output means may be configured in the form of a video port, an S-video port, an audio port, a serial port, a parallel port, a universal serial bus port, a firewire port, an infrared port, a radio frequency port, or the like. The output means might also be a suitable image recording medium, e.g., a magnetic disc, memory card or the like. The output means may be configured on the back, the side, or the front of the multimedia memorial.

The display means of the multimedia memorial may be configured in the form of a liquid crystal display, an electroluminescent display, or the like. The display means may also be configured in the form of a touch sensitive screen (“touch screen”) With a touch screen, a user can select from options displayed on the display means' viewing surface by touching the surface adjacent the desired option or, in some designs, by touching the option directly. The display means may use a reflected light display, i.e. it may be illuminated by ambient light for power conservation.

The multimedia memorial is configured to operate stand alone and/or via a remote central server with the ability to transmit/receive updates in the future via a transmission medium such as the Internet. This could enable a user to load multimedia data externally from a remote server via the Internet to the multimedia memorial via the receiver. The multimedia data is stored in the memory means, and the stored multimedia data is read out from the memory means. Normally, the memory means will store computer software according to the invention which includes program instructions defining the controlling logic. The microprocessor means implements the programmed control instructions. The controlling logic instructions may be coded in a variety of programming languages consistent and compatible with the associated hardware. The memory means give and take the data to and from the input means or output means under control of the microprocessor means. The microprocessor means reproducibly processes the multimedia data supplied from the memory means and supplies the processed result to the display means. The microprocessor means also reproducibly processes audio data supplied from the memory means and supplies the processed result to an audio signal output portion, such as a speaker means.

The display may advance automatically or the user may advance the display. The user touches or speaks to function means associated with the display means which provides direct forward movement. The function means may be any known function means, such as mechanical buttons, slide trigger switches, crossed beams of infrared light, acoustic surface waves, capacitance sensing, resistive membranes, touch screen, voice recognition or the like, associated with the display means by which the address memory is activated directly and calls up the next multimedia sequence from the memory means. Activation of the function means by depression, sliding, etc., signals the microprocessor means to send to the display means what is stored in the memory means. The multimedia memorial may also be activated by voice recognition. Connected to the microprocessor means is an additional memory in which further multimedia signals are stored. This memory makes it possible to feed in text fade-ins, thus making the display means extremely flexible. Signals from the additional memory are fed to a mixer, in order to be released to the display means either mixed with, or chronologically relocated in relation to the information in the memory means. Also provided is a speaker and/or audio headphone jack by means of which audio signals can be released. This speaker may be fed either directly from the additional memory or also through a mixer.

As described above, the multimedia memorial of the present invention may be configured as stand-alone or for use with the Internet network. The Internet network is a large, quasi-public network having many users. The Internet is a network of computer networks that links together millions of computer systems. World Wide Web servers store multi-media information in a document format known as HyperText Markup Language (HTML). HTML provides basic document formatting and allows a developer to specify links to other servers and files. The World Wide Web servers distribute HTML formatted documents using a specific communication protocol known as the HyperText Transfer Protocol (HTTP). HTTP is a known application protocol that provides users access to files (which can be in different formats such as text, graphics, images, sound, video, etc.). Use of an HTML-compliant client browser involves specification of a link via a Uniform Resource Locator. Upon such specification, the client computer makes a transmission control protocol/Internet protocol (TCP/IP) request to the server identified in the link and receives a web page (namely, a document formatted according to HTML) in return. Multimedia memorial customers may be individuals who have established an authorized connection with the central server. Each multimedia memorial may be linked to the central server. The central server may pull together text, images, graphics, and sounds to present information associated with a particular multimedia memorial customer.

Options such as buttons and menus may be placed on the display means by which the user would select a particular feature by clicking on the option. The stand-alone multimedia memorial accessibility of operation may be through a locally installed password and/or password protection via a central server. Such a central server may then access a database of memorial customers to obtain an access code and/or a password for a particular memorial customer. The central server may ask for an access code and/or password. Once an access code is obtained, the server would lookup the memorial customer's profile in the database.

The multimedia memorial may be configured in any one of a plurality of configurations. The multimedia memorial may be integrated within a gravestone marker. An audio device may be used independently or in conjunction with the multimedia memorial. A multimedia memorial may be merely attached to a gravestone marker. A multimedia memorial may be stored in a weather resistant container that is positioned near a gravestone marker. Such a container may be immersed in the ground and secured via means of an anchor. The multimedia memorial may be positioned in the ground in front of a gravestone marker. The multimedia memorial may also be integrated within any type of sentimental item, such as an urn or the like.

Accordingly, it is a principal object of the invention to provide a multimedia memorial comprising a housing, power supply means, an input means, a memory means, a microprocessor means, a display means for displaying a number of still images or successive moving images, a speaker means, and an output means.

It is another object of the invention to provide a multimedia memorial which may be interconnected with the Internet.

It is an object of the invention to provide improved elements and arrangements thereof in a multimedia memorial for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front, perspective view of a multimedia memorial according to the invention that is integrated within a gravestone marker.

FIG. 2 is a multimedia memorial according to the invention.

FIG. 3 is an audio device which may be used in independently or in conjunction with a multimedia memorial according to the invention.

FIG. 4 is a multimedia memorial according to the invention that is merely attached to a gravestone marker.

FIG. 5 is a multimedia memorial according to the invention that is stored in a weather resistant container positioned near a gravestone marker.

FIG. 6 is the weather resistant container shown in FIG. 5.

FIGS. 7A, 7B and 7C illustrate an anchor lock for the weather resistant container shown in FIG. 6.

FIG. 8 is a front, perspective view a multimedia memorial according to the invention that is remotely positioned in the ground in front of a gravestone marker.

FIG. 9 is the remotely positioned multimedia memorial shown in FIG. 8.

FIG. 10 is a front, perspective view a multimedia memorial according to the invention that is integrated within an urn.

FIG. 11 is a block diagram of a multimedia memorial playback device according to the present invention.

Similar reference characters denote corresponding features consistently throughout the attached drawings.

### DETAILED DESCRIPTION OF THE PREFERRED EMBODIMENTS

The present invention is a multimedia memorial. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

The multimedia memorial comprises a housing, power supply means, an input means, a memory means, a microprocessor means, a display means for displaying a number of still images or successive moving images, a speaker means, and an output means. The size of the housing is suitably designed insofar as it may be conveniently fixed in a convenient location according to the desires of the user, preferably near or associated with a sentimental item, such as a gravestone marker for an individual or an animal, such as a pet. The housing may be configured in the form of a non-breakable exterior pod or shell. The multimedia memorial may also include a receiver and/or transmitter, such as a transceiver for receiving and/or transmitting information. Such a receiver may be configured for being responsive to navigation signals transmitted by a satellite navigation system and for providing information describing the memorial's location based on the navigation signals, i.e. a global positioning system (GPS) receiver.

The power supply means of the multimedia memorial may be solar cell means. However, the power supply means may include any suitable power source, such as conventional storage batteries, rechargeable storage batteries, an electric outlet, or the like. The multimedia memorial includes appropriate drive circuitry associated therewith. The device may include a modem, cellular phone, wireless networking, or the like to be used in connecting with a PDA device, pocket PC, computer, the Internet or the like, for transferring and/or receiving data.

The input means of the multimedia memorial can receive image data from an image recording medium on which image data is recorded, such as a compact disk, magnetic disc, a memory card, or the like. The input means may alternatively be configured in the form of a data port to enable data transfer and communication between the multimedia memorial and external peripheral devices. Such a data port may include a video port, an S-video port, an audio port, a serial port, a parallel port, a universal serial bus port, a firewire port, an infrared port, a radio frequency port, or the like. A universal serial bus port is a new type of port and data communication protocol that will permit a plurality of newly designed peripheral devices to be connected to the multimedia memorial in a daisy chain configuration. A firewire port is an audio/video digital interface according to the Institute of Electrical and Electronics Engineers 1394 standard. The other types of ports are well known to one skilled in the art. The input means may be configured on the back, the side, or the front of the multimedia memorial housing.

Such an image recording medium can be inserted into an opening in the input means. The image recording medium has a storage capacity with which image data representing a plurality of images can be recorded and with which sound can be recorded. The image data and the sound data can also be recorded on the image recording medium in a mixed state. Image data is read from the image recording medium and converted into digital signals by using a file reader means or a disc reader. The digital signals are stored in the memory means and displayed on the display means. The microprocessor means also contains an address memory by means of which the relevant images in the memory means can be called up. The address memory may be an EPROM or some other erasable programmable-read-only-memory. The address memory may also be replaceable, so that, if necessary, a programmed memory, corresponding to a relevant image, can be used. If the address memory is located in the microprocessor means, changes are relatively easy to make. The content of the memory means is processed successively by the microprocessor means. With the addresses and functional signals corresponding to the image data, the desired images are called up from the memory means and displayed on the display means. The memory means stores software code which includes program instructions defining the controlling logic. The microprocessor means implements the programmed control instructions. The controlling logic instructions may be coded in a variety of programming languages consistent and compatible with the particular hardware means employed.

Major known electrical components are mounted within the multimedia memorial and an external bus interface for upgrades and communication options. The components include a printed circuit board mounted in firm support within the multimedia memorial. The circuit board carries certain coupling and driver electronics with the microprocessor, read-only memories (ROM) and random access memories (RAM). In general, the ROM memories are used to contain instructions and programs while the RAM memories are employed for operating and working data. Of course, movement and process of instructions as well as data is controlled and accomplished by the microprocessor. The microprocessor is variously connected to the other elements of the multimedia memorial. The memories are connected to the microprocessor through several signal paths.

The output means of the multimedia memorial can output image data from the memory means on which image data is stored. The output means may be configured in the form of a video port, an S-video port, an audio port, a serial port, a parallel port, a universal serial bus port, a firewire port, an infrared port, a radio frequency port, or the like. The output means might also be a suitable image recording medium, e.g., a magnetic disc, memory card or the like. The output means may be configured on the back, the side, or the front of the multimedia memorial.

The display means of the multimedia memorial may be configured in the form of a liquid crystal display, an electroluminescent display, or the like. The display means which may also be configured in the form of a touch sensitive screen (“touch screen”). With a touch screen, a user can select from options displayed on the display means' viewing surface by touching the surface adjacent the desired option or, in some designs, by touching the option directly. The display means may use a reflected light display, i.e. it may be illuminated by ambient light for power conservation.

As described above, the multimedia memorial is configured to operate stand alone and/or via a remote central server with the ability to transmit/receive updates in the future via a transmission such as the Internet. This could enable a user to load multimedia data externally from a remote server via the Internet to the multimedia memorial via a receiver. The multimedia data is stored in the memory means, and the stored multimedia data is read out from the memory means. Normally, the memory means will store computer software according to the invention which includes program instructions defining the controlling logic. The microprocessor means implements the programmed control instructions. The controlling logic instructions may be coded in a variety of programming languages consistent and compatible with the associated hardware. The memory means give and take the data to and from the input means or output means under control of the microprocessor means. The microprocessor means reproducibly processes the multimedia data supplied from the memory means and supplies the processed result to the display means. The microprocessor means also reproducibly processes audio data supplied from the memory means and supplies the processed result to an audio signal output portion, such as a speaker means.

The display may advance automatically or the user may advance the display. The user touches or speaks to function means associated with the display means which enables the user to selectively review image segments. The function means may be any known function means, such as mechanical buttons, slide trigger switches, crossed beams of infrared light, acoustic surface waves, capacitance sensing, resistive membranes, touch screen, voice recognition or the like, associated with the display means by which the address memory is activated directly and calls up the next multimedia sequence from the memory means. Activation of the function means by depression, sliding, etc., signals the microprocessor means to send to the display means what is stored in the memory means. The multimedia memorial may also be activated by voice recognition. Connected to the microprocessor means is an additional memory in which further multimedia signals are stored. This memory makes it possible to feed in text fade-ins, thus making the display means extremely flexible. Signals from the additional memory are fed to a mixer, in order to be released to the display means either mixed with, or chronologically relocated in relation to the information in the memory means. Also provided is a speaker and/or audio headphone jack by means of which audio signals can be released. This speaker may be fed either directly from the additional memory or also through a mixer.

The multimedia memorial of the present invention may be configured as a stand-alone or for use with the Internet network. The Internet network is a large, quasi-public network having many users. The Internet is a network of computer networks that links together millions of computer systems. World Wide Web servers store multi-media information in a document format known as HyperText Markup Language (HTML). HTML provides basic document formatting and allows a developer to specify links to other servers and files. The World Wide Web servers distribute HTML formatted documents using a specific communication protocol known as the HyperText Transfer Protocol (HTTP). HTTP is a known application protocol that provides users access to files (which can be in different formats such as text, graphics, images, sound, video, etc.). Use of an HTML-compliant client browser involves specification of a link via a Uniform Resource Locator. Upon such specification, the client computer makes a transmission control protocol/Internet protocol (TCP/IP) request to the server identified in the link and receives a web page (namely, a document formatted according to HTML) in return. Multimedia memorial customers may be individuals who have established an authorized connection with the central server. Each multimedia memorial may be linked to the central server. Such a central server may pull together text, images, graphics, and sounds to present information associated with a particular multimedia memorial customer.

Options such as buttons and menus may be placed on the display means by which the user would select a particular feature by clicking on the option. The stand-alone multimedia memorial accessibility of operation may be through a locally installed password protection and/or password protection via a central server. Such a central server may then access a database of memorial customers to obtain an access code and/or a password for a particular memorial customer. The central server may ask for an access code and/or password. Once an access code is obtained, the server would lookup the memorial customer's profile in the database.

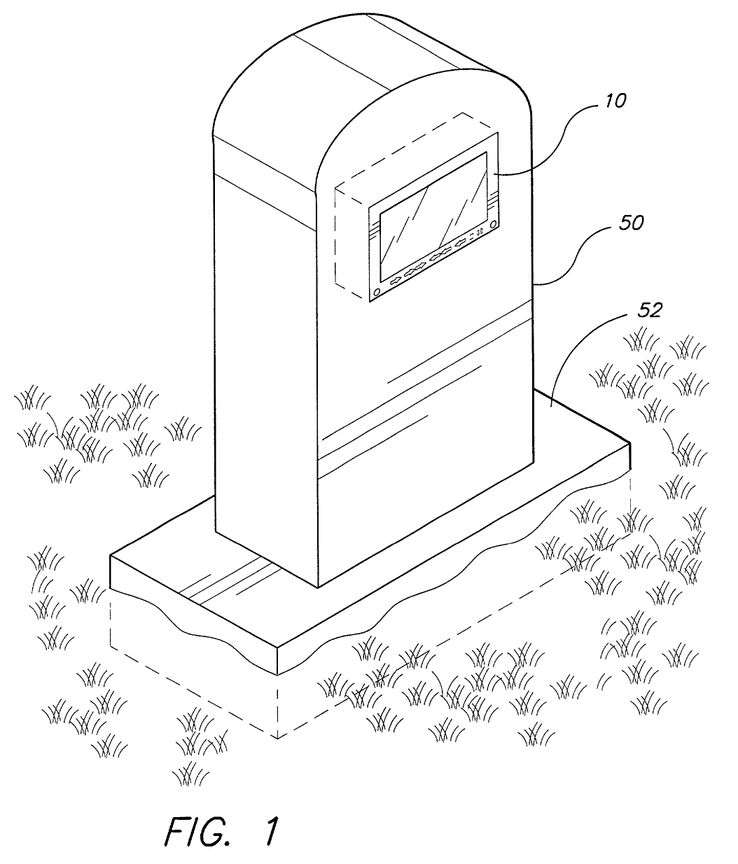

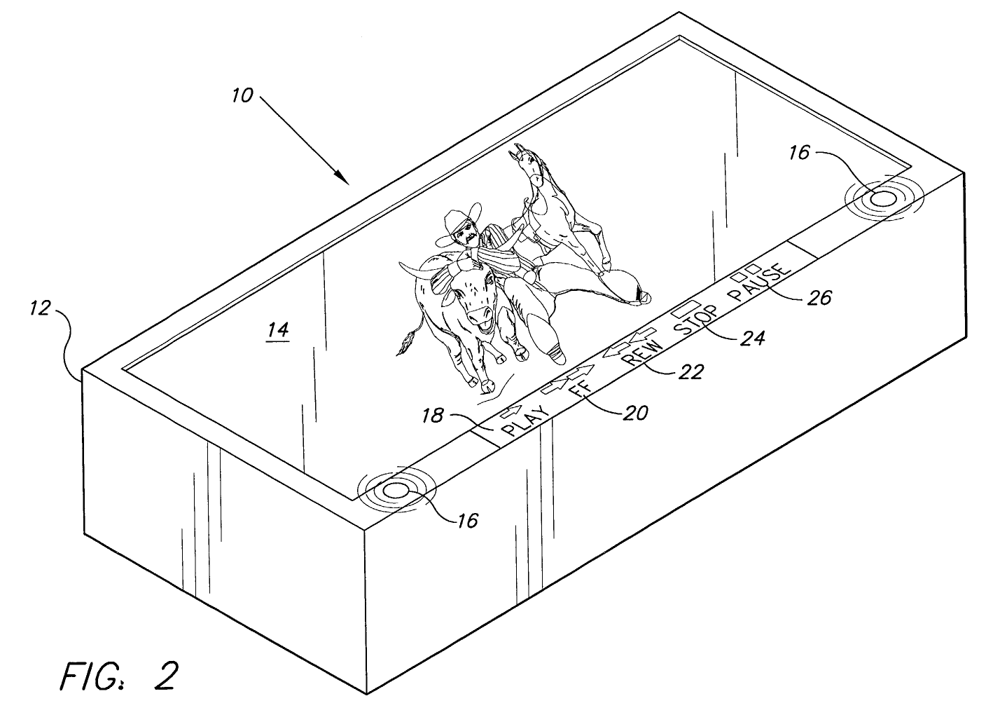

The multimedia memorial may be configured in any one of a number of configurations. The multimedia memorial essentially comprises a multimedia playback device in combination with a means for disposing the playback device at a gravesite. As shown in FIG. 1, a multimedia memorial 10 may be integrated within a gravestone marker 50 by housing the memorial 10 in a recess define in the gravestone marker 50. The gravestone marker 50 is mounted on a base 52 which is submerged in the ground. (It will be obvious to those skilled in the art that instead of being integrated into an upright gravestone, the multimedia memorial 10 may be integrated into a flat grave marker, with the housing 12 depending from the marker.) The multimedia memorial 10 is shown in more detail in FIG. 2. The multimedia memorial 10 comprises a housing 12, a display 14 for displaying a number of still images or successive moving images, and a speaker 16. The multimedia memorial 10 also includes function means 18,20,22,24,26 associated with the display means 14 which provides direct forward movement.

The function means 18,20,22,24,26 may be any known function means, such as mechanical buttons, slide trigger switches, crossed beams of infrared light, acoustic surface waves, capacitance sensing, resistive membranes, or the like, associated with the display 14. For example, the display 14 may be a liquid crystal display (LCD) touch screen in which the functions 18,20,22,24,26 are buttons displayed on the screen with capacitive sensing or resistive membranes for activating the functions. Activation of the function means by depression, sliding, etc., signals the microprocessor means to effect a particular function. As shown the functions include PLAY, FAST FORWARD, REWIND, STOP, and PAUSE. Obviously, these functions are not required and any of a number of other functions may also be included according to the desires of the user. The function means may also include functions for activating menus which permit the user to select a multimedia record to be viewed, such as photographs of the deceased, video images, eulogies, biographical material, etc.

The multimedia memorial 10 may also be activated by voice recognition. The size of the housing 12 is suitably designed insofar as it may be conveniently integrated within the gravestone marker 50. The housing 12 may be configured in the form of a non-breakable exterior pod or shell. The multimedia memorial 10 may also include a receiver and/or transmitter, such as a transceiver for receiving and/or transmitting information. Such a receiver may be configured for being responsive to navigation signals transmitted by a satellite navigation system and for providing information describing the memorial's location based on the navigation signals, i.e. a global positioning system (GPS) receiver.

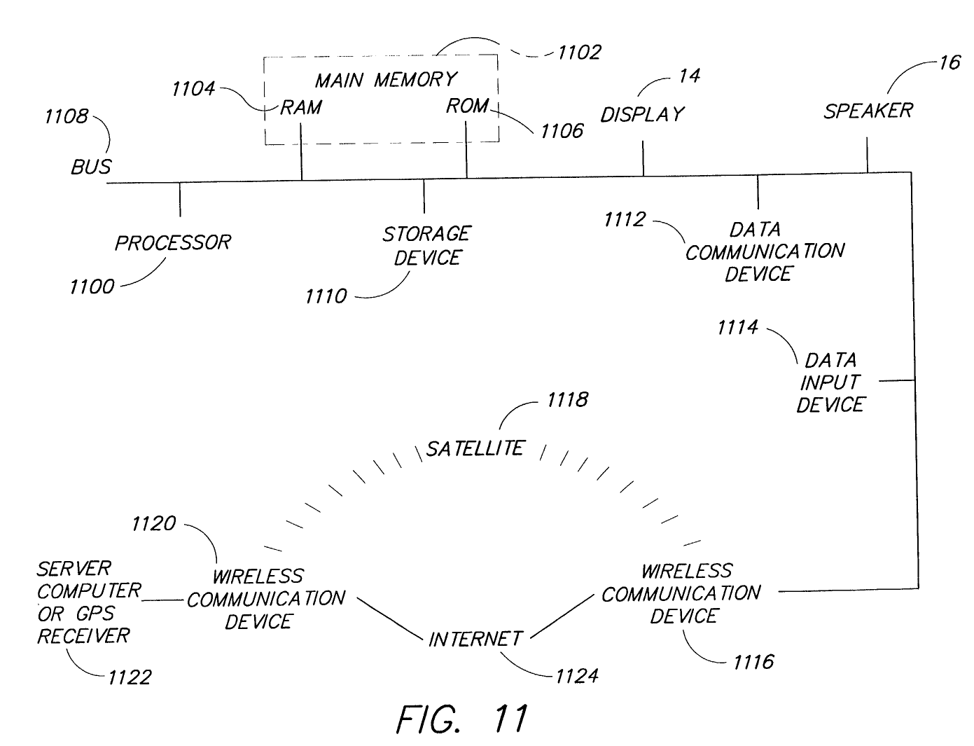

FIG. 11 is a block diagram of the various components which be contained within the housing 12. The multimedia memorial 10 may include a microprocessor 1100 and an area of main memory 1102 including random access memory (RAM) 1104 and read only memory (ROM) 1106 connected by one or more data buses 1108. Also connected to the data buses are a storage device 1110 (including magnetic storage media, such as a hard disk), display 14, a data communication device 1112 such as a modem, a speaker 16, one or more data input devices 1114 such as a keyboard, CD-ROM drive, cassette drive for reading magnetic video or audio cassettes, etc, and a wireless communication device 1116 such as a cell phone, radio frequency transceiver, GPS transceiver, or the like.

The wireless communication device 1116 may be a GPS transceiver which receives satellite signals from orbiting GPS satellites 1118, computes the gravesite latitude and longitude coordinates using software stored in storage device 1110 and loaded into main memory 1102 and operating under the control of processor 1100, or using software integrated into the transceiver, and then transmits those coordinates through a satellite transponder 1118 or otherwise so that a mobile wireless communication device 1120 may receive the coordinates and determine directions to the gravesite using a GPS receiver 1122. Alternatively, the wireless communication device 1116 may be any device for connecting the multimedia memorial 10 to the Internet 1124, and thence to a server computer 1122 which is also connected to a wireless communication device 1120. The server computer 1122 may provide a larger storage capacity for multimedia files concerning the deceased, which can then be replayed by selection of the user through the multimedia memorial 10 at the gravesite, and may also provide means for permitting distant relatives and friends who are unable to visit the gravesite to update the multimedia archives for viewing by visitors to the gravesite.

The housing 12 would also encase a conventional power supply for operating the foregoing components, which may be a long-life dry cell battery (such as a lithium battery), rechargeable batteries, or solar panels. The multimedia playback component of the multimedia memorial may comprise a custom built device, or it may comprise one or more conventional devices. For example, the multimedia memorial 10 may include a portable, laptop personal computer equipped with a speaker, and optionally including a touch screen or optionally connected to a GPS transceiver or wireless Internet capable device. Alternatively, the multimedia memorial 10 may comprise a television (which may be Internet ready) with a VCR or DVD player.

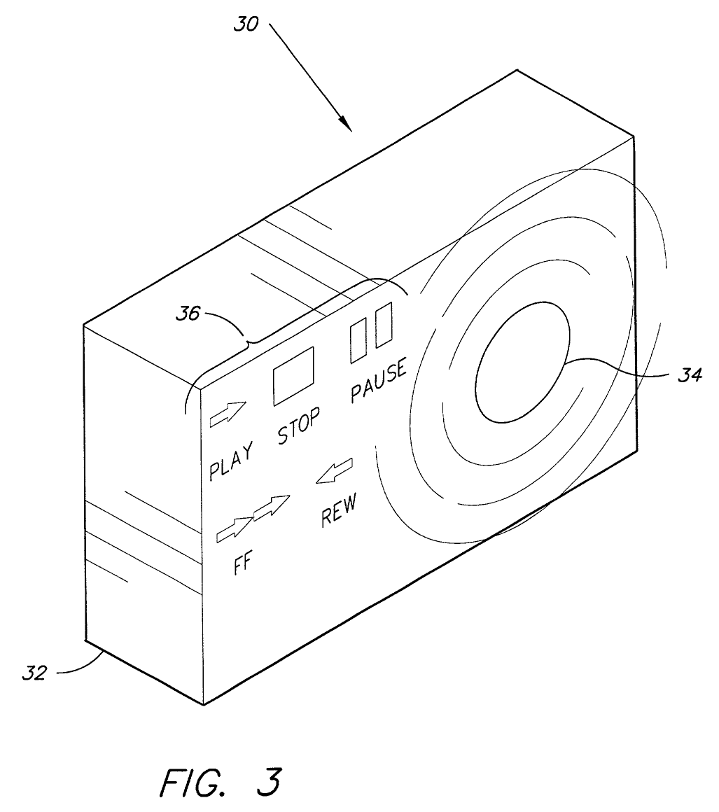

FIG. 3 illustrates an audio device which may be used in independently or in conjunction with the multimedia memorial shown in FIG. 1. The audio device 30 includes a housing 32, power supply means (not shown), an input means (not shown), a memory means (not shown), a microprocessor means (not shown), speaker means 34, and an output means (not shown). The audio device 10 also includes function means 36 which enables a user to selectively listen to audio segments. As shown the functions include PLAY, FAST FORWARD, REWIND, STOP, and PAUSE. Obviously, these functions are not required and any of a number of other functions may also be included according to the desires of the user. The audio device may be a digital device, such as an MP3 player (digital walkman, palm pilot, etc.) or an analog device (cassette tape player).

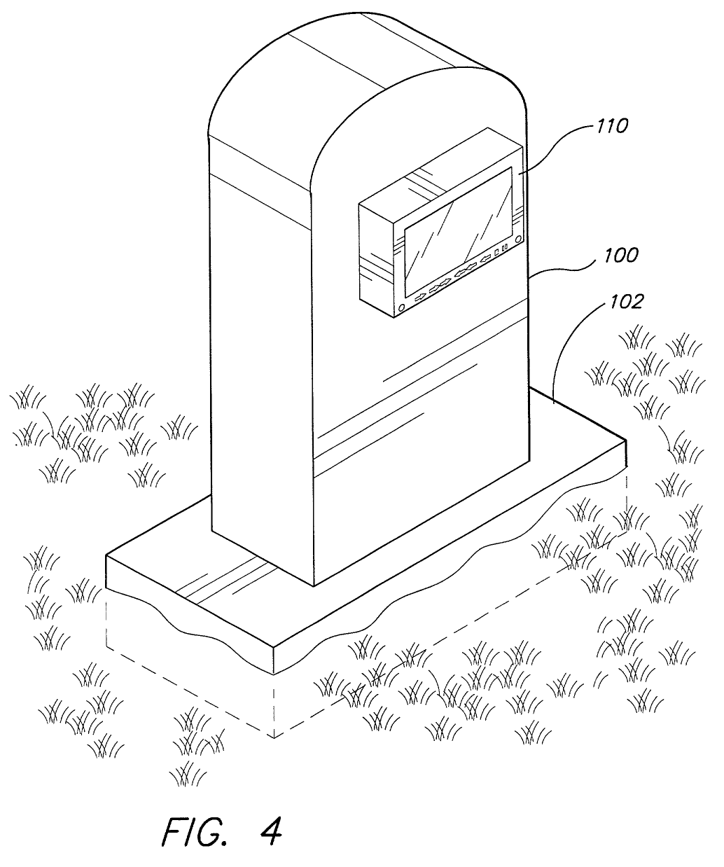

FIG. 4 illustrates a multimedia memorial 110 which is merely attached to a gravestone marker 100. The gravestone marker 100 is mounted on a base 102 which is submerged in the ground. The multimedia memorial 110 is substantially similar to the multimedia memorial 10 shown in FIG. 2. The multimedia memorial 110 comprises a housing, power supply means (not shown), an input means (not shown), a memory means (not shown), a microprocessor means (not shown), a display means for displaying a number of still images or successive moving images, speaker means, and an output means (not shown). The multimedia memorial also includes function means associated with the display means which enables a user to selectively review image segments. The function means may be any known function means, such as mechanical buttons, slide trigger switches, crossed beams of infrared light, acoustic surface waves, capacitance sensing, resistive membranes, or the like, associated with the display means. Activation of the function means by depression, sliding, etc., signals the microprocessor means to effect a particular function. As shown the functions include PLAY, FAST FORWARD, REWIND, STOP, and PAUSE. Obviously, these functions are not required and any of a number of other functions may also be included according to the desires of the user. The multimedia memorial 110 may also be activated by voice recognition. The size of the housing is suitably designed insofar as it may be conveniently affixed to the gravestone marker. The housing may be configured in the form of a non-breakable exterior pod or shell. The multimedia memorial 110 may also include a receiver and/or transmitter, such as a transceiver for receiving and/or transmitting information. Such a receiver may be configured for being responsive to navigation signals transmitted by a satellite navigation system and for providing information describing the memorial's location based on the navigation signals, i.e. a global positioning system (GPS) receiver.

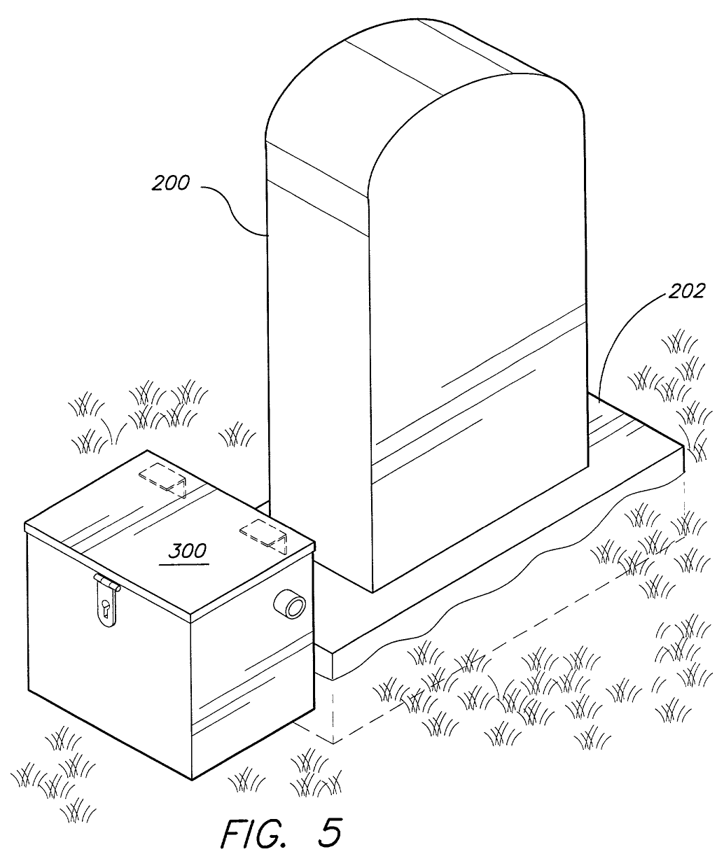

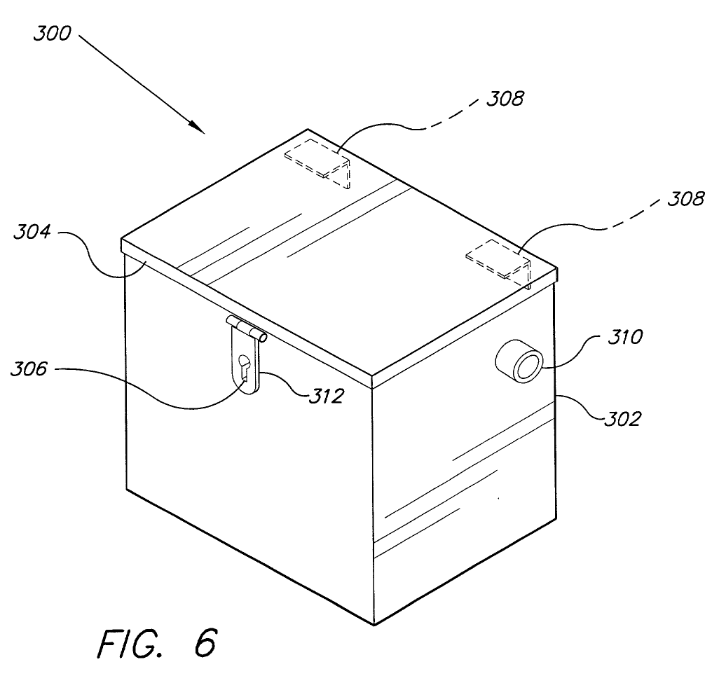

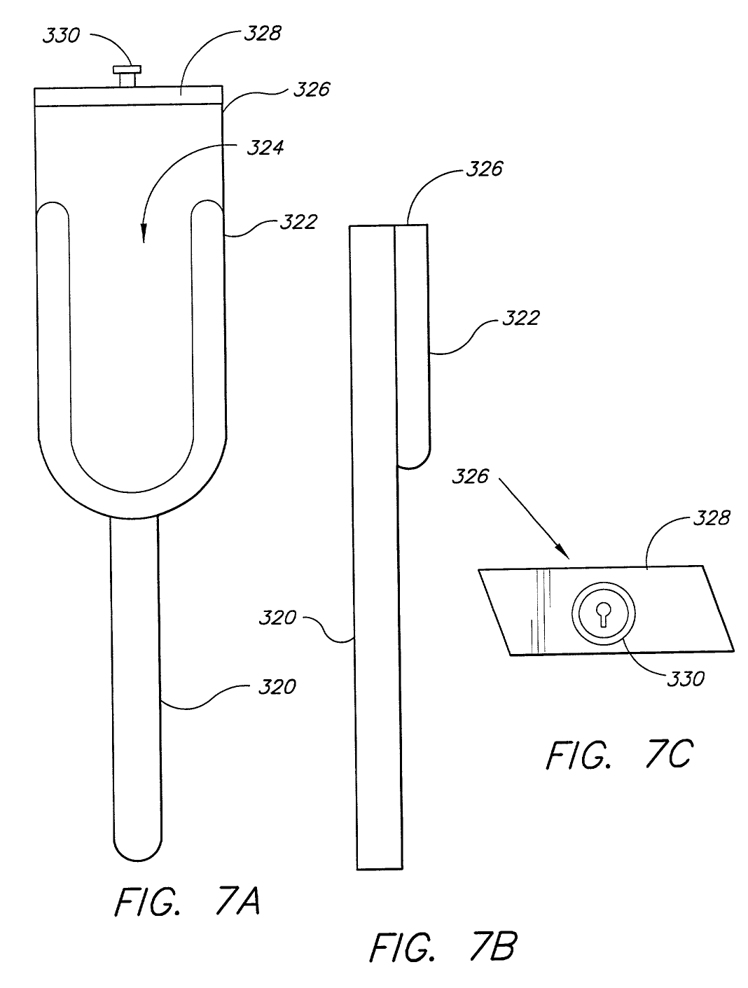

FIG. 5 illustrates a multimedia memorial (not shown) which is stored in a weather resistant container or box 300 that is positioned near a gravestone marker 200. As shown in FIG. 6, the weather resistant container 300 includes a base container 302 and a cover 304 attached to the base container via hinges 308. The hinges 308 are internal hinges, for security purposes. The container 300 has a hinged lock plate 312 with a key lock 306 for restricting unauthorized access to the container 300 attached to the cover 304. Obviously, the container 300 may be immersed in the ground and secured via anchor means as shown in FIGS. 7A-7C.

As shown in FIGS. 7A, 7B, and 7C, each anchor comprises a steel rod 320 with a metal clip 322 attached, as by welding. The clip 322 defines a U-shaped slot 324 which slidably receives a knob or button 310 (one shown in FIG. 6, the opposite side of the box 300 being symmetrical) disposed on opposite sides of the box 306. A cover 326, comprising a plate 328 and a locking cylinder 330 slidable in the steel rod 320, is lowered over the clip 322 so that the plate 328 closes the slot 324 in order to prevent removal of the box 300 and the cylinder 330 is locked to latch the cover 326 in place. The anchor rods 320 may be embedded directly in the ground or anchored in concrete footings in spaced apart relation to receive the box 300.

The multimedia memorial contained within the water resistant container 300 is substantially similar to the multimedia memorial 10 shown in FIG. 2. The multimedia memorial comprises a housing, power supply means (not shown), an input means (not shown), a memory means (not shown), a microprocessor means (not shown), a display means for displaying a number of still images or successive moving images, speaker means, and an output means (not shown). The multimedia memorial also includes function means associated with the display means which enables a user to selectively review image segments. The function means may be any known function means, such as mechanical buttons, slide trigger switches, crossed beams of infrared light, acoustic surface waves, capacitance sensing, resistive membranes, or the like, associated with the display means. Activation of the function means by depression, sliding, etc., signals the microprocessor means to effect a particular function. As shown the functions include PLAY, FAST FORWARD, REWIND, STOP, and PAUSE. Obviously, these functions are not required and any of a number of other functions may also be included according to the desires of the user. The multimedia memorial may also be activated by voice recognition.

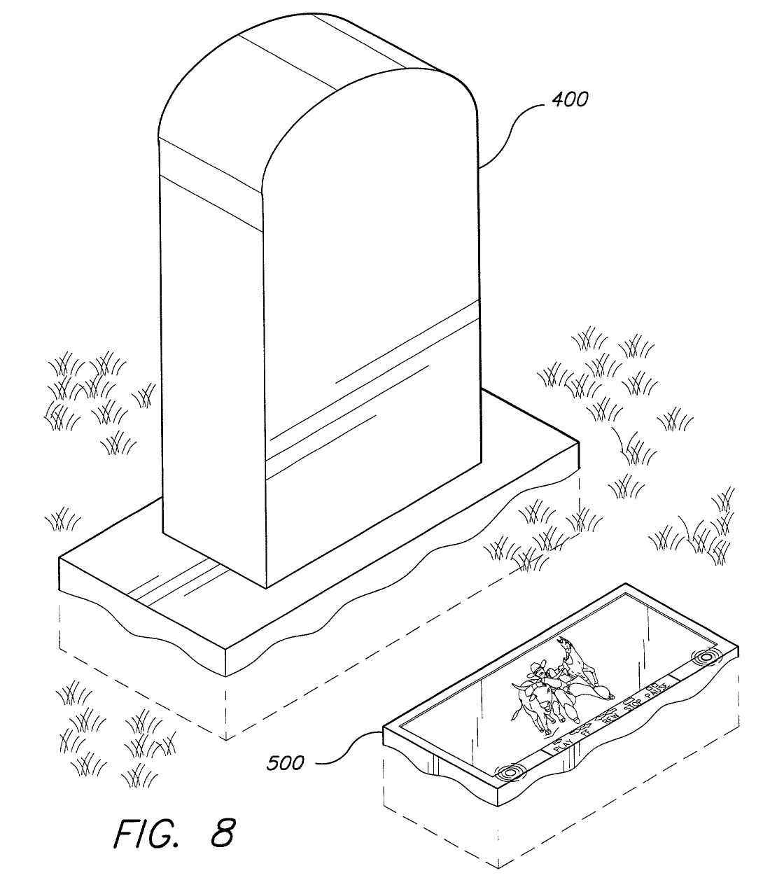

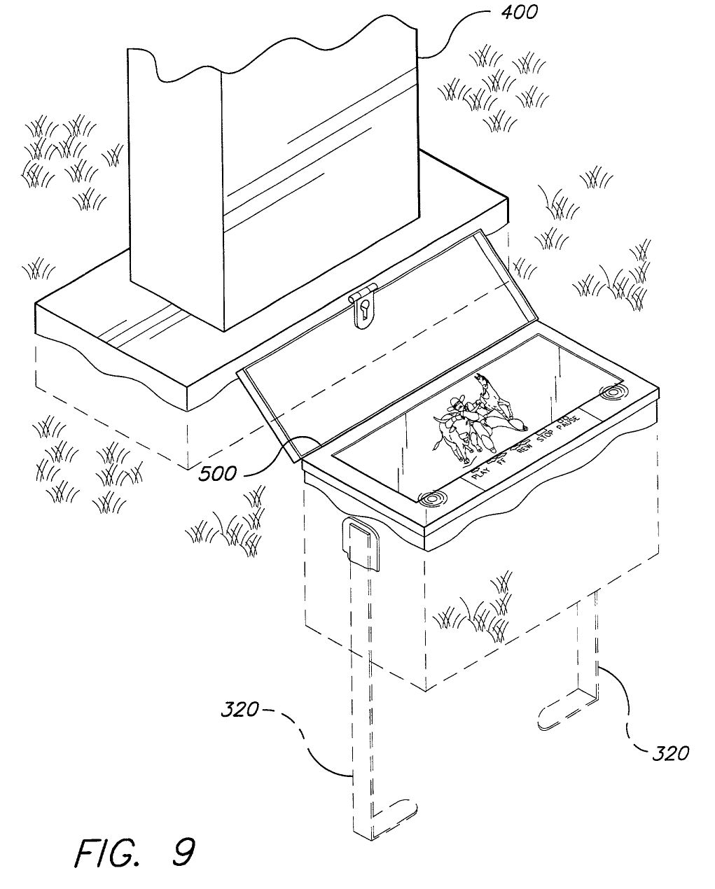

FIG. 8 shows a multimedia memorial 500 according to the invention that is remotely positioned in the ground in front of a gravestone marker 400. FIG. 9 shows the remotely positioned multimedia memorial 500 shown in FIG. 8. The multimedia memorial 500 is stored in a weather resistant container that is positioned near the gravestone marker 400. As shown in FIG. 6, the weather resistant container 300 includes a weather resistant base container 302 and a weather resistant cover 304 attached to the base container via hinge means 308. The weather resistant cover may be opaque or transparent (i.e., made from automotive safety glass, polycarbonate, etc.) to enable visitors to view the display during any weather conditions. The container is immersed in the ground and secured via anchor means as shown in FIGS. 7A-7C. The multimedia memorial 500 comprises a housing, power supply means (not shown), an input means (not shown), a memory means (not shown), a microprocessor means (not shown), a display means for displaying a number of still images or successive moving images, speaker means, and an output means (not shown). The multimedia memorial also includes function means associated with the display means which enables a user to selectively review image segments. The function means may be any known function means, such as mechanical buttons, slide trigger switches, crossed beams of infrared light, acoustic surface waves, capacitance sensing, resistive membranes, or the like, associated with the display means. Activation of the function means by depression, sliding, etc., signals the microprocessor means to effect a particular function. As shown the functions include PLAY, FAST FORWARD, REWIND, STOP, and PAUSE. obviously, these functions are not required and any of a number of other functions may also be included according to the desires of the user. The multimedia memorial may also be activated by voice recognition.

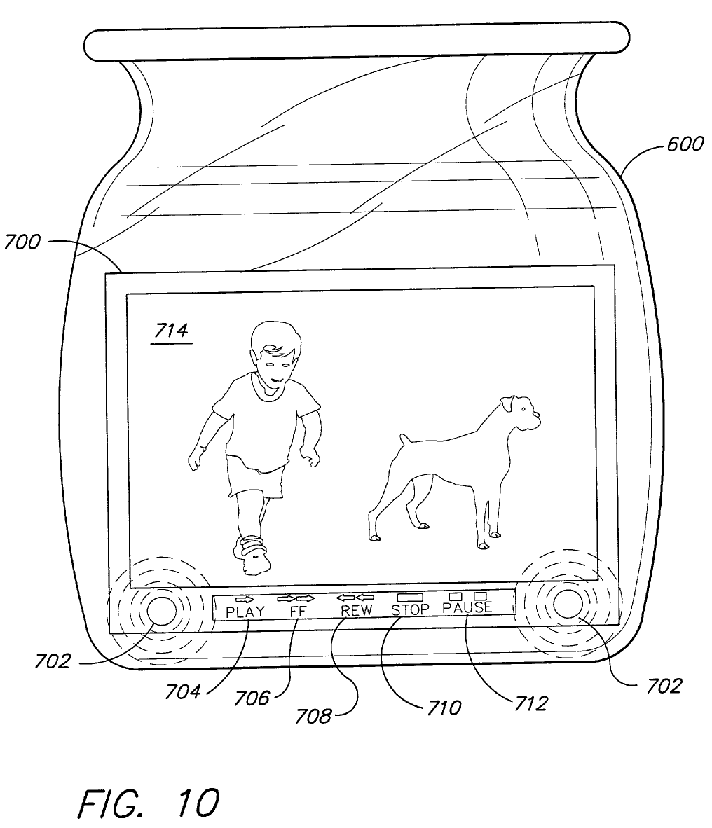

FIG. 10 shows a multimedia memorial 700 that is integrated within an urn 600. The multimedia memorial 700 comprises a housing, power supply means (not shown), an input means (not shown), a memory means (not shown), a microprocessor means (not shown), a display means 714 for displaying a number of still images or successive moving images, speaker means 702, and an output means (not shown). The multimedia memorial also includes function means 704, 706, 708, 710, 712 associated with the display means which enables a user to selectively review image segments. The function means may be any known function means, such as mechanical buttons, slide trigger switches, crossed beams of infrared light, acoustic surface waves, capacitance sensing, resistive membranes, or the like, associated with the display means. Activation of the function means by depression, sliding, etc., signals the microprocessor means to effect a particular function. As shown the functions include PLAY, FAST FORWARD, REWIND, STOP, and PAUSE. obviously, these functions are not required and any of a number of other functions may also be included according to the desires of the user. The multimedia memorial may also be activated by voice recognition. obviously, a multimedia memorial according to the invention may be integrated or associated with any alternative type of sentimental item.

It is to be understood that the present invention is not limited to the sole embodiments described above, but encompasses any and all embodiments within the scope of the following claims.

I claim:

1. A multimedia memorial for commemorating a decedent at a grave site, comprising:
(a) a multimedia playback device for playing multimedia recordings relating to a decedent; and
(b) means for disposing said multimedia playback device at the decedent's gravesite.

2. The multimedia device according to claim 1, wherein said multimedia playback device comprises a personal computer having:
(a) a processor, an area of main memory for executing program code under the direction of the processor, a storage device for storing data and program code, and at least one bus connecting the processor, the main memory area, and the storage device;
(b) data input means for inputting a multimedia data file into the memory of said personal computer;
(c) display means for displaying images coded in the multimedia data file; and
(d) speaker means for the output of audio coded in the multimedia data file.

3. The multimedia device according to claim 2, further comprising selection means for selecting a multimedia file for display.

4. The multimedia device according to claim 2, further comprising:
(a) a data communications device connected to said at least one bus; and
(b) a wireless Internet connection means for connecting said multimedia device to the Internet for downloading multimedia files from a server computer storing multimedia files commemorating the decedent.

5. The multimedia device according to claim 4, in combination with a server computer storing multimedia files commemorating the decedent.

6. The multimedia device according to claim 2, further comprising:
(a) a global positioning system transceiver connected to said at least one bus; and
(b) software means for determining the location of said transceiver from global positioning satellite signals, whereby said transceiver is capable of transmitting the location of said grave site in global positioning system coordinates.

7. The multimedia device according to claim 2, further comprising function means for controlling the playback of multimedia by said multimedia playback means.

8. The multimedia device according to claim 2, wherein said display means comprises a touch screen.

9. The multimedia device according to claim 1, wherein said multimedia playback device comprises:
(a) a video display means for displaying video and an accompanying audio track; and
(b) a cassette playback means connected to said video display means for receiving and playing back video cassettes commemorating the decedent.

10. The multimedia device according to claim 1, wherein said multimedia playback device comprises an analog audio playback device for playing back an audio cassette tape commemorating the decedent.

11. The multimedia device according to claim 1, wherein said multimedia playback device comprises an digital audio playback device for playing back a digital sound file commemorating the decedent.

12. The multimedia device according to claim 1, wherein said multimedia playback device comprises:
(a) a microprocessor;
(b) a memory means connected to the processor for storing and operating software programs under the control of the microprocessor for displaying multimedia files commemorating the decedent;
(c) input means for inputting a multimedia data file into said memory means;
(d) display means for displaying a number of still images and successive moving images;
(e) speaker means for the output of audio;
(f) output means for outputting multimedia files to an external device;
(g) a power supply connected to said microprocessor; and
(h) a housing, said microprocessor, said power supply, said memory means, said display means, said speaker means, said input means and said output means being disposed in said housing.

13. The multimedia device according to claim 12, further comprising function means for controlling the playback of multimedia by said multimedia playback means.

14. The multimedia memorial according to claim 13, wherein said function means comprises PLAY, FAST FORWARD, REWIND, STOP, and PAUSE functions.

15. The multimedia memorial according to claim 1, wherein said means for disposing comprises a grave marker having a recess defined therein, said multimedia playback device being integrated into the recess.

16. The multimedia memorial according to claim 1, wherein said means for disposing comprises an urn having a recess defined therein, said multimedia playback device being integrated into the recess.

17. The multimedia memorial according to claim 1, wherein said means for disposing comprises a weather resistant container including:
(a) a box-shaped base container having a cover pivotally attached to the container; and
(b) a lock attached to said cover for locking the cover in a closed position.

18. The multimedia memorial according to claim 17, wherein said container is adapted for attachment to a grave marker.

19. The multimedia memorial according to claim 17, wherein said box shaped container has a first side wall and a second side wall opposing said first side wall, said means for disposing further comprising:
(a) a pair of knobs, one of said knobs projecting from said first side wall and the other said knob projecting from said second side wall; and
(b) a pair of anchors embedded in the ground in spaced apart relation at a grave site, each of the anchors having:
(i) a rod having a first end adapted for embedment in the ground and having a hollow second end;
(ii) a metal clip attached to the second end of said rod, the clip defining a U-shaped slot; and
(iii) a cover including a flat plate and a lock cylinder attached to the plate and slidable in the hollow second end of said rod, said cover being disposable over
said U-shaped slot;
whereby the knobs projecting from the opposing sidewalls of said container may be inserted in the slots defined in said metal clips and said cover disposed over said slots with said lock cylinder latched in order to secure said container at a grave site.

20. The multimedia memorial according to claim 17, wherein the cover of said container is transparent, whereby a display on said multimedia playback device is viewable without opening the cover of said container.
